(19) United States
(12) Patent Application Publication
(10) Pub. No.: US 2010/0027528 A1
(43) Pub. Date: Feb. 4, 2010

(54) Notification of Impending Media Gateway Resource Exhaustion

(75) Inventors: Charles Lewis Davidson, Middletown, NJ (US); Jeffrey Meis, Broomfield, CO (US); Thorsten Fredrik Ohrstrom Sandgren, Thornton, CO (US); Mark Daniel Rajcok, Toms River, NJ (US); Sujesha Sudevan Sudevalayam, Mumbai (IN); Ajay Jagdish Talreja, Pune (IN)

Correspondence Address: Avaya;DEMONT & BREYER, LLC, 100 COMMONS WAY, STE 250, HOLMDEL, NJ, 07733, US

(73) Assignee: AVAYA TECHNOLOGY LLC, Basking Ridge, NJ (US)

(21) Appl. No.: 11/935,933

(22) Filed: Nov. 6, 2007

(51) Int. Cl. H04L 12/66

(52) U.S. Cl. 370/352

(57) ABSTRACT

A method is disclosed that enables a media gateway controller to optimize the selection of a media gateway from which to acquire call-related resources, in a multi-gateway environment. In accordance with the illustrative embodiment, the controller sets a high utilization threshold and a low utilization threshold for each media gateway it controls, for the purpose of receiving a notification when a threshold is crossed. As resources are utilized, removed from service, or become available for use, the media gateway recalculates the resource utilization of one or more predetermined resources and notifies the controller if a threshold for a particular resource has been crossed. The controller, in turn, uses the current threshold states as part of the selection of media gateway to serve one or more subsequent calls. The disclosed method can increase the probability of selecting a media gateway with sufficient resources for a successful call completion on the first attempt.

### FIELD OF THE INVENTION

The present invention relates to telecommunications in general, and, more particularly, to a media gateway exchanging resource-related information with a media gateway controller.

### BACKGROUND OF THE INVENTION

A modern telecommunications system often comprises one or more switched telephone networks and one or more Internet Protocol-based packet networks. These two different types of networks are interconnected by a media gateway, which acts as a translator between the two types of networks. The media gateway enables multimedia communications, such as voice and video, over multiple transport protocols end to end.

Because the media gateway connects different types of networks, one of its main functions is to convert between the different transmission and coding techniques used across the different networks. For example, a Voice-over-Internet-Protocol-capable (VoIP-capable) media gateway performs the conversion bi-directionally between time division multiplexed (TDM) voice media that originate at a switched telephone network telecommunications terminal and VoIP datagram media that is intended for an Internet Protocol network terminal, as part of a telephone conversation between two parties. Other functions that the media gateway provides are echo cancellation, tone detection, tone generation (e.g., dual tone multi-frequency tones, etc.), conferencing, call classification, and announcement recording and playback. Performing each of these functions requires the use of various combinations of resources that are provided by the media gateway.

With respect to providing connectivity across the different networks, each packet stream that is received from the Internet Protocol network comprises data packets and control packets. The VoIP media gateway converts the received packets to a time division multiplexed stream while processing the control packets. The media gateway must perform the conversion in a timely manner to minimize the possibility of packet loss, which the listening party on a call might perceive. To handle all of the packets responsively and without unacceptable delay or jitter, the media gateway uses digital signal processors, which are dedicated devices that are capable of the high-speed packet processing that is required for the conversion. Each digital signal processor comprises multiple processing resources, such as processing channels, to handle multiple calls and the different conversion formats across the calls. For example, the conversion formats might be distinguished from one another by codec type, encryption algorithm, payload values, addressing information, or redundancy in the information transmitted. Protocol standards and formulas exist that govern these properties, such as G.711 and G.729 compression/decompression algorithms. Similarly, the media gateway must also perform the conversion in the other direction from a time division multiplexed stream to Internet Protocol packets in a timely manner.

One or more media gateways are controlled by a media gateway controller, which provides the call control and signaling functionality for each media gateway and across media gateways. Communication between media gateways and media gateway controllers is achieved by means of protocols such as H.248, Media Gateway Control Protocol (MGCP), and so forth. During a call initialization that involves an Internet Protocol (IP) terminal, the media gateway controller provides to the IP terminal the IP address of the media gateway resource that is handling the call. This enables the IP terminal to specify the proper destination address of the packets that it originates and to recognize the packets that are being sent to the terminal. Alternatively, instead of a call involving an IP terminal, the call could involve another media gateway that exchanges packets with the aforementioned media gateway resource that is handling the call.

The media gateway controller and a selected media gateway work together to set up a call between a telecommunications terminal in one type of network, such as the IP network, and a terminal in another type of network, such as the switched telephone network. First, as part of a resource negotiation the media gateway controller requests the selected media gateway that it has selected to provide a list of available signal processing resources from among those that are supported by the IP terminal. The media gateway determines what resources are available and what conversion formats can be accommodated by those resources. Normally, the media gateway controller proceeds to select a resource, provides the necessary addressing information to the IP terminal involved in the call, and responds back to the media gateway with an indication of the assigned resource.

In an H.248-enabled system, after a media gateway's resources become exhausted or unavailable, a media gateway controller will still try to acquire resources from the media gateway to set up the call connection. The H.248 protocol itself only provides standardized ways for the media gateway to indicate a lack of available resources during resource negotiation. If the negotiation fails, such as for lack of resources, the media gateway controller must release any resources that were previously acquired for the call connection and then search for other available resources, such as at other media gateways. This can lengthen call setup times.

What is needed is an improved technique for a media gateway controller to select a media gateway, in a multi-gateway environment, without some of the disadvantages in the prior art.

### SUMMARY OF THE INVENTION

The present invention enables a media gateway controller to optimize the selection of a media gateway from which to acquire call-related resources, in a multi-gateway environment. In particular, the illustrative embodiment of the present invention comprises a method for each media gateway to indicate that it is approaching resource exhaustion, as well as a method to indicate that resource exhaustion is no longer an issue.

In accordance with the illustrative embodiment, the media gateway controller sets a high utilization threshold and a low utilization threshold for each media gateway it controls, for the purpose of receiving a notification when a threshold is crossed. As resources are utilized, removed from service, or become available for use, the media gateway recalculates the resource utilization of one or more predetermined resources and notifies the controller if a threshold for a particular resource has been crossed.

The controller, in turn, uses the current threshold states, in terms of whether a threshold for each resource being monitored has been crossed, as part of the selection of a media gateway to serve one or more subsequent calls. This is advantageous over some techniques in the prior art, in that it can increase the probability of selecting a media gateway with sufficient resources for a successful call completion on the first setup attempt. As a result, the technique of the illustrative embodiment minimizes media gateway controller cleanup activities that are associated with unsuccessful attempts at acquiring resources, and it minimizes activities that are related to finding alternative resources.

The illustrative embodiment of the present invention comprises: transmitting, from a media gateway controller to a first media gateway, i) a first upper threshold for a predetermined resource and ii) a resource request for a first call; receiving, from the first media gateway, a first notification that a first result exceeds the first upper threshold, the first result being based on a first calculation of resource utilization with respect to the predetermined resource at the first media gateway; and selecting one of i) the first media gateway and ii) a second media gateway to handle the first call, the selected media gateway being based on the first notification.

### BRIEF DESCRIPTION OF THE DRAWINGS

FIG. 1 depicts a schematic diagram of telecommunications system 100, in accordance with the illustrative embodiment of the present invention.

FIGS. 2A through 2C depict the salient messages that are exchanged throughout system 100, as well as the corresponding events that occur, in accordance with the illustrative embodiment of the present invention.

### DETAILED DESCRIPTION

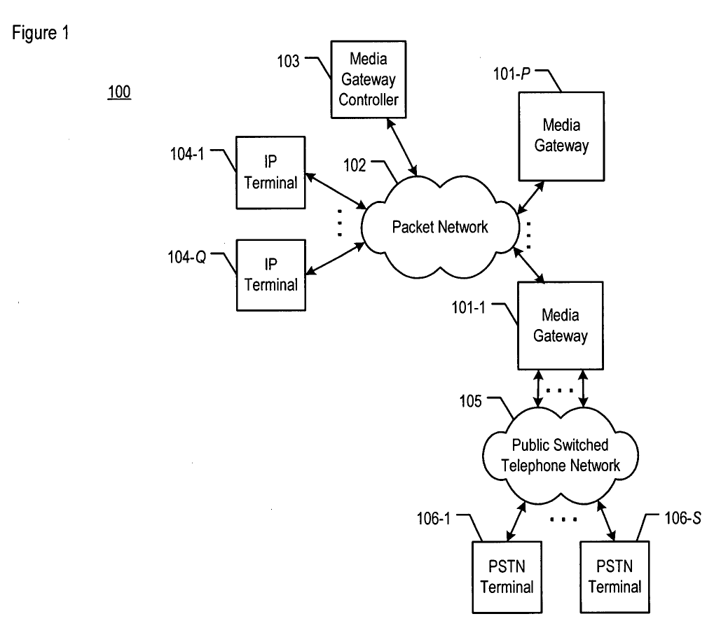

FIG. 1 depicts a schematic diagram of telecommunications system 100, in accordance with the illustrative embodiment of the present invention. Telecommunications system 100 comprises:
i. media gateways 101-1 through 101-P, wherein P is a positive integer;
ii. Internet Protocol (IP) packet network 102;
iii. media gateway controller 103;
iv. IP telecommunications terminals 104-1 through 104-Q, wherein Q is a positive integer;
v. Public Switched Telephone Network (PSTN) 105; and
vi. PSTN telecommunications terminals 106-1 through 106-S, wherein S is a positive integer;
   All of the elements depicted in FIG. 1 are interconnected as shown.

Media gateway 101-p, for p=1 through P, is a data-processing system that comprises media gateway functionality that is known in the art, acting as a translator between two types of networks in well-known fashion; as depicted, media gateway 101-1 acts as a translator between Internet Protocol network 102 and Public Switched Telephone Network 105, which network is described below. Media gateway 101-p enables multimedia communications, such as voice and video, over multiple transport protocols from one terminal in one network to another terminal in another network, in part by working in concert with media gateway controller 103 to set up, maintain, and terminate calls.

Because media gateway 101-p, including media gateway 101-1, connects different networks, one of its main functions is to convert between the different transmission and coding techniques uses across the different networks. In accordance with the illustrative embodiment, media gateway 101-1 is a Voice-over-Internet-Protocol-capable (VoIP-capable) media gateway that performs the conversion between time division multiplexed voice signals that originate at a switched telephone network telecommunications terminal, such as one of terminals 106-1 through 106-S, and VoIP signals that are intended for an Internet Protocol network terminal, such as one of IP terminals 104-1 through 104-Q, as part of a telephone conversation between two parties. Media gateway 101-1 performs the conversion in the reverse direction as well (i.e., from an IP terminal to a PSTN terminal) and is able to perform bidirectional conversion for multiple calls concurrently.

Media gateway 101-1 in the illustrative embodiment comprises voice packet-processing functionality. However, as those who are skilled in the art will appreciate, in some alternative embodiments of the present invention, media gateway 101-p is able to process packets that contain other types of bearer information such as video.

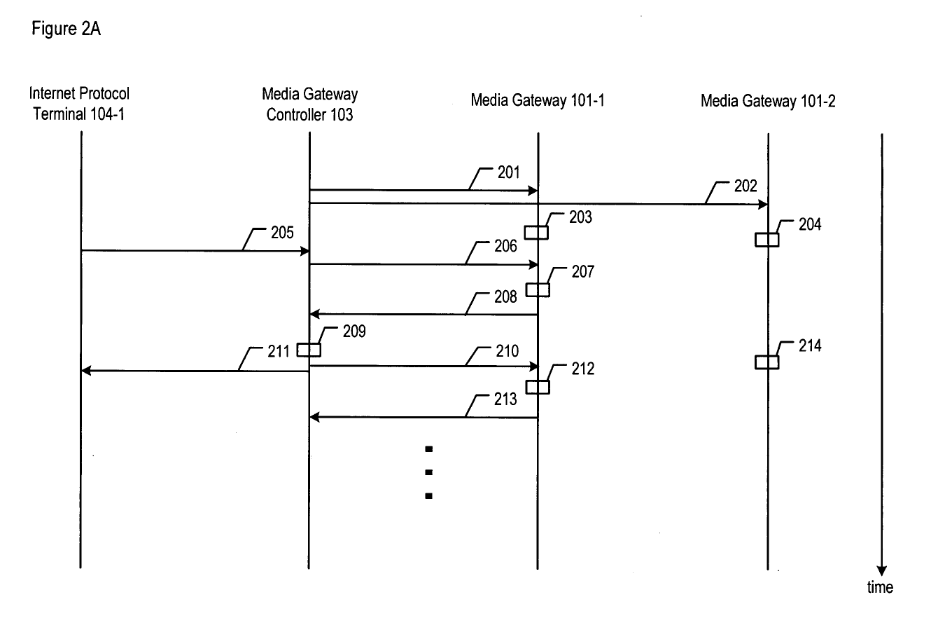

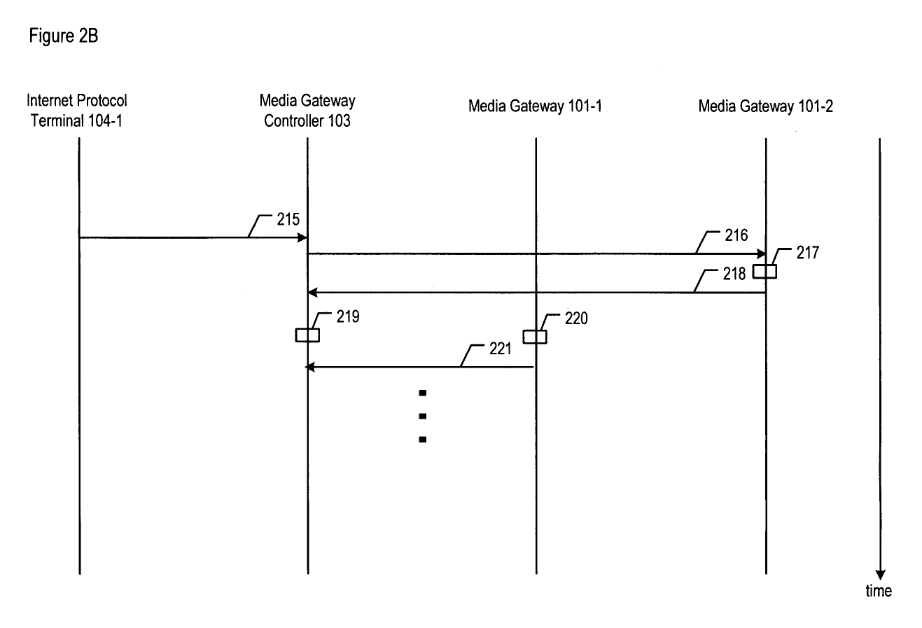

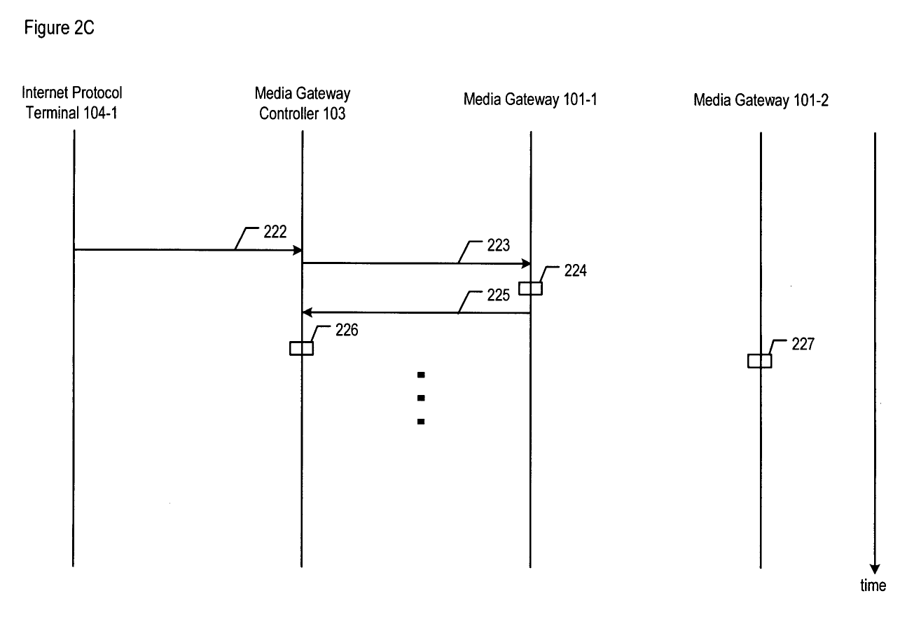

Additionally, media gateway 101-p executes some of the tasks described below and with respect to FIGS. 2A through 2C in supporting the functionality of the illustrative embodiment. Although a media gateway executes the tasks of the illustrative embodiment, in some alternative embodiments another type of data-processing system can be used to execute those tasks, as those who are skilled in the art will appreciate. In any event, it will be clear to those skilled in the art, after reading this specification, how to make and use media gateway 101-p.

As depicted, media gateway 101-1 is interconnected with a plurality of networks, including Internet Protocol Packet Network 102 and Public Switched Telephone Network 105. Internet Protocol packet network 102 comprises one or more transmission-related nodes such as routers that are used to direct data packets from one or more sources to the correct destinations of those packets. Network 102 is capable of handling, in well-known fashion, Internet Protocol-based messages that are transmitted among two or more Internet Protocol-capable devices such as (i) one or more IP terminals 104-1 through 104-Q and (ii) a media gateway such as gateway 101-1, or between media gateway controller 103 and a media gateway. Public Switched Telephone Network 105 comprises one or more transmission-related nodes such as switches that are used to direct call-related signals from one or more sources to the correct destinations of those signals. Network 105 is capable of handling, in well-known fashion, either analog or digital bearer information in circuit-switched calls among two or more devices such as (i) one or more PSTN terminals 106-1 through 106-S and (ii) media gateway 101-1.

As those who are skilled in the art will appreciate, telecommunications system 100, and in particular media gateway 101-p, is capable in some alternative embodiments of handling other types of networks and other combinations of networks than depicted. Furthermore, in some alternative embodiments, each network might in turn comprise additional networks, such as cellular telephone networks and local area networks that are either wired or wireless. For example, in some embodiments network 102 might comprise a local area network (e.g., of a business enterprise, etc.), in which one or more of IP terminals 104-1 through 104-Q operate.

Media gateway controller 103 is a data-processing system that comprises media gateway controller functionality that is known in the art, controlling media gateways 101-1 through 101-P. Controller 103 provides the call control and signaling functionality for each media gateway 101-p, in well-known fashion. Additionally, controller 103 executes some of the tasks described below and with respect to FIGS. 2A through 2C in supporting the functionality of the illustrative embodiment. Although a media gateway controller executes the tasks of the illustrative embodiment, in some alternative embodiments another type of data-processing system can be used to execute those tasks, as those who are skilled in the art will appreciate.

In accordance with the illustrative embodiment, controller 103 is physically discrete from media gateways 101-1 through 101-P. However, as those who are skilled in the art will appreciate, in some alternative embodiments, the functionality of controller 103 and the functionality of one or more gateways 101-1 through 101-P might co-exist with each other (i.e., by sharing the same processor, memory, or other resources). In any event, it will be clear to those skilled in the art, after reading this specification, how to make and use media gateway controller 103.

Media gateway controller 103 and media gateway 101-p communicate with each other via the H.248 protocol, in accordance with the illustrative embodiment. As those who are skilled in the art will appreciate, in some alternative embodiments controller 103 and gateway 101-p can communicate in accordance with a different type of call-control protocol and can handle datagram packets other than Internet Protocol packets.

FIG. 1 also depicts multiple telecommunications terminals of various types. Internet Protocol-capable endpoints such as SIP desksets and laptop-based or desktop-based softphones are represented by terminals 104-1 through 104-Q. Plain Old Telephone Service (POTS) terminals, Integrated Services Digital Network (ISDN) phones, cell phones, and other PSTN-associated terminals are represented by terminals 106-1 through 106-S. As those who are skilled in the art will appreciate, the present invention is also applicable to other combinations of terminals than depicted.

FIGS. 2A through 2C depict the salient messages that are exchanged between Internet Protocol telecommunications terminal 104-1, media gateway controller 103, and media gateways 101-1 and 101-2, as well as the corresponding events that occur, in accordance with the illustrative embodiment of the present invention. It will be clear to those skilled in the art which events depicted in FIGS. 2A through 2C can occur simultaneously or in a different order than that depicted.

For pedagogical purposes, terminal 104-1 as depicted represents the telephone of a user who is making multiple telephone calls. Additionally, media gateways 101-1 and 101-2 as depicted represent the gateway facilities in the example that handle calls that involve terminal 104-1. But it will be clear to those skilled in the art, after reading this specification, how to make and use embodiments of the present invention that support message exchanges involving different numbers of terminals and media gateways than depicted.

At some point during its operation, media gateway controller 103 transmits messages 201 and 202 to media gateway 101-1 and 101-2, respectively. Each of the messages contains an upper utilization threshold for a predetermined resource such as digital signal processing channels, User Datagram Protocol (UDP) ports, TDM timeslots, or other resources that correspond to any of the functions performed by a media gateway. In some embodiments, the messages also contain a lower utilization threshold for the predetermined resource. Each set of upper threshold and lower threshold is used by the media gateway receiving it, for the purpose of monitoring the usage of the resource. As those who are skilled in the art will appreciate, the sets of upper and lower utilization thresholds transmitted to the media gateways can be different from one another or they can be the same. Furthermore, each predetermined resource being monitored at each media gateway can have its own dedicated set of upper and lower thresholds. And even though FIG. 2A depicts a single set of transmissions (i.e., messages 201 and 202), controller 103 in some embodiments can transmit the thresholds to one or more media gateways more than once during operation. For example, controller 103 might have to adjust one or more threshold values, based on information received during ongoing operation.

At event 203, in response to having received message 201, media gateway 101-1 performs a calculation of resource utilization with respect to one or more different resources. In general, media gateway 101-1 updates the resource utilization calculations with respect to the one or more resources whenever those resources are requested, utilized, removed from service, become available for use, or have otherwise changed in status. In some embodiments, the gateway can update the calculations even independently of a change in resource status, such as periodically or sporadically. Other events that trigger a calculation will be identified elsewhere in the discussion of FIGS. 2A through 2C. If a resource utilization threshold is crossed, the gateway notifies the controller of the event.

At event 204, in response to having received message 202, media gateway 101-2 also performs a calculation of resource utilization, as described above and with respect to event 203. If a resource utilization threshold is crossed, the gateway notifies the controller of the event.

At some point, terminal 104-1 receives an indication (e.g., an “off hook” condition, etc.) from its user that the user wishes to make a call. In response, terminal 104-1 transmits message 205 to media gateway controller 103, requesting that a call be set up between terminal 104-1 and the specified other endpoint, such as one of the PSTN terminals (e.g., terminal 106-3, etc.).

Media gateway controller 103 then transmits message 206 to the particular media gateway that is able to provide access to the called terminal, in this case gateway 101-1. Message 206 is a resource request by controller 103 that starts a negotiation for call-related, signal processing resources that are present at gateway 101-1. The message comprises the type of information coding that IP terminal 104-1 can handle, such as G.711 and/or G.729 coding, as well as other information relevant to both the call and to media gateway 101-1.

At event 207, in response to having received message 206, media gateway 101-1 performs a calculation of resource utilization with respect to one or more of the resources being negotiated for by controller 103. Further in response to having received message 206, the gateway transmits message 208 to controller 103, providing a survey of the available resources that can serve the call. The information contained in message 208 comprises the Internet Protocol address and as the UDP port number of each available resource, along with type of information that the available resources are able to process.

In accordance with the illustrative embodiment, message 208 further comprises a notification when the resource calculation exceeds the upper utilization threshold. In some embodiments, message 208 comprises a notification when the resource calculation falls below the lower utilization threshold. The notification itself can include the resource utilization level actually calculated or merely serve as an indication that one of the thresholds has been crossed. As those who are skilled in the art will appreciate, in some embodiments, the notification might be part of a message other than message 208 or might comprise other information related to resource status, or both.

Upon receiving message 208, controller 103 at event 209 selects a processing resource from those identified in message 208 to serve the call. For pedagogical purposes, it is assumed that controller 103 did not receive a notification from media gateway 101-1 that a resource utilization threshold had been crossed. As a result, media gateway controller 103 then notifies gateway 101-1 via message 210 and IP terminal 104-1 via message 211 of its selection of the particular processing resource that will serve the call. Gateway 101-1 normally uses the information in message 210 to determine which processing resource is to be allocated to the call. IP terminal 104-1 uses the information in message 211 to determine, as part of the call, (i) where to send its outgoing packets going forward, (ii) which incoming packets are intended for the terminal, and (iii) how to process the packets.

At event 212, in response to having received message 210, media gateway 101-1 performs a calculation of resource utilization with respect to one or more of the resources selected by controller 103. If a resource utilization threshold is crossed, the gateway notifies the controller of the event. In the example, the upper utilization threshold has, in fact, been exceeded, and gateway 101-2 notifies the controller of the event via message 213.

Meanwhile, at event 214, media gateway 101-2 performs a calculation of resource utilization with respect to one or more of its resources, as part of a periodic survey. If a resource utilization threshold is crossed, the gateway notifies controller 103 of the event.

Now referring to FIG. 2B, later on and in preparation for a new call, terminal 104-1 receives an indication from its user that the user wishes to make another call. In response, terminal 104-1 transmits message 215 to media gateway controller 103, requesting that a call be set up.

Media gateway controller 103 then transmits message 216 to the particular media gateway that is able to provide access to the called terminal, in this case gateway 101-2. Controller 103 selects gateway 101-2 over gateway 101-1 because of the notification that the controller had received as part of message 213, or as part of a similar message, which indicated that the resource utilization of one of the resources at gateway 101-1 had exceeded its upper utilization threshold. As discussed earlier with respect to message 206, message 216 is a resource request by controller 103 that starts a negotiation for signal processing resources that are present at gateway 101-2.

At event 217, in response to having received message 216, media gateway 101-2 performs a calculation of resource utilization with respect to one or more of the resources being negotiated for by controller 103. Further in response to having received message 216, the gateway transmits message 218 to controller 103, providing a survey of the available resources that can serve the call, as described earlier with respect to message 208.

In accordance with the illustrative embodiment, message 218 further comprises a notification when the resource calculation exceeds the upper utilization threshold. In some embodiments, message 218 comprises a notification when the resource calculation falls below the lower utilization threshold. The notification itself can include the resource utilization level actually calculated or merely serve as an indication that one of the thresholds has been crossed. As those who are skilled in the art will appreciate, in some embodiments, the notification might be part of a message other than message 218.

Upon receiving message 218, at event 219 gateway controller 103 proceeds to set up the call, as described earlier and with respect to the events which follow the reception of message 208.

Meanwhile, at event 220, media gateway 101-1 performs a calculation of resource utilization with respect to one or more of its resources, as part of a periodic survey or because enough time had elapsed since the previous survey had taken place. If a resource utilization threshold is crossed, the gateway notifies controller 103 of the event. In the example, the calculated resource utilization has, in fact, fallen below the low utilization threshold, and gateway 101-1 notifies the controller of the event via message 221. For instance, a “faulted” digital signal processor might have become usable again, thereby making additional resources available and causing the calculated resource utilization to drop, in relation to the number of usable resources.

Now referring to FIG. 2C, later on and in preparation for a new call, terminal 104-1 receives an indication from its user that the user wishes to make yet another call. In response, terminal 104-1 transmits message 222 to media gateway controller 103, requesting that a call be set up.

Media gateway controller 103 then transmits message 223 to the particular media gateway that is able to provide access to the called terminal, in this case gateway 101-1. Controller 103 selects gateway 101-1 over gateway 101-2 because of the notification that the controller had received as part of message 221, or as part of a similar message, which indicated that the resource utilization of one of the resources at gateway 101-1 had fallen below its lower utilization threshold. As discussed earlier with respect to message 206, message 223 is a resource request by controller 103 that starts a negotiation for signal processing resources that are present at gateway 101-1.

At event 224, in response to having received message 223, media gateway 101-1 performs a calculation of resource utilization with respect to one or more of the resources being negotiated for by controller 103. Further in response to having received message 223, the gateway transmits message 225 to controller 103, providing a survey of the available resources that can serve the call, as described earlier with respect to message 208.

In accordance with the illustrative embodiment, message 225 further comprises a notification when the resource calculation exceeds the upper utilization threshold. In some embodiments, message 225 comprises a notification when the resource calculation falls below the lower utilization threshold. The notification itself can include the resource utilization level actually calculated or merely serve as an indication that one of the thresholds has been crossed. As those who are skilled in the art will appreciate, in some embodiments, the notification might be part of a message other than message 225.

Upon receiving message 225, at event 226 gateway controller 103 proceeds to set up the call, as described earlier and with respect to the events which follow the reception of message 208.

Meanwhile, at event 227, media gateway 101-2 performs a calculation of resource utilization with respect to one or more of its resources, as part of a periodic survey. If a resource utilization threshold is crossed, the gateway notifies controller 103 of the event.

FIGS. 2A through 2C depict some examples of when media gateway controller 103 might select one media gateway over another. As those who are skilled in the art will appreciate, after reading this specification, controller 103 might select one media gateway over another based on other, non-depicted combinations of upper utilization thresholds and lower utilization thresholds (i.e., of media gateways 101-1, 101-2, and so forth) across resources and/or across media gateways. As some examples of how different combinations of threshold status can be used, controller 103 might select a second media gateway over a first media gateway, based on the following conditions:
i. having received a notification that the resource utilization at the first media gateway exceeds the upper utilization threshold;
ii. having received a notification that the resource utilization at the second media gateway falls below the lower utilization threshold;
iii. having received notifications that the resource utilizations at the first media gateway and second media gateway both exceed the respective upper utilization thresholds, but where the notification from the second gateway arrived more recently (or earlier, in some alternative embodiments);
iv. having received notifications that the resource utilizations at the first media gateway and second media gateway both exceed the respective upper utilization thresholds, but where the upper utilization threshold for the resource at the second gateway is set lower than the threshold at the first gateway (or is set higher, in some alternative embodiments);
v. having received notifications that the resource utilizations at the first media gateway and second media gateway both exceed their respective upper utilization thresholds, but where notifications have been received from the first media gateway for more than one type of resource; or
vi. two or more of the above-listed conditions in combination with one another.
   As those who are skilled in the art will appreciate, after reading this specification, other conditions can be used for selecting a second media gateway over a first media gateway.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
transmitting, from a media gateway controller to a first media gateway, i) a first upper threshold for a predetermined resource and ii) a resource request for a first call;
receiving, from the first media gateway, a first notification that a first result exceeds the first upper threshold, the first result being based on a first calculation of resource utilization with respect to the predetermined resource at the first media gateway; and
selecting one of i) the first media gateway and ii) a second media gateway to handle the first call, the selected media gateway being based on the first notification.

2. The method of claim 1 further comprising:
transmitting, from the media gateway controller to the second media gateway, a second upper threshold for the predetermined resource; and
receiving, from the second media gateway, a second notification that a second result exceeds the second upper threshold, the second result being based on a second calculation of resource utilization with respect to the predetermined resource at the second media gateway;
wherein the selection of one of i) the first media gateway and ii) the second media gateway to handle the first call is also based on the second notification.

3. The method of claim 2 further comprising:
transmitting, from the media gateway controller to the first media gateway, a first lower threshold for the predetermined resource, wherein the first lower threshold is less than the first upper threshold;
receiving, from the first media gateway, a third notification that a third result falls below the first lower threshold, the third result being based on a third calculation of resource utilization with respect to the predetermined resource at the first media gateway; and
selecting one of i) the first media gateway and ii) a second media gateway to handle a second call, the selected media gateway being based on the third notification.

4. The method of claim 1 further comprising:
transmitting, from the media gateway controller to the second media gateway, a second lower threshold for the predetermined resource, wherein the second lower threshold is less than the second upper threshold; and
receiving, from the second media gateway, a fourth notification that a fourth result falls below the second lower threshold, the fourth result being based on a fourth calculation of resource utilization with respect to the predetermined resource at the second media gateway;
wherein the selection of one of i) the first media gateway and ii) the second media gateway to handle the first call is also based on the fourth notification.

5. The method of claim 1 wherein the predetermined resource is digital signal processing channels.

6. The method of claim 1 wherein the predetermined resource is UDP ports.

7. The method of claim 1 wherein the media gateway controller transmits the resource request in accordance with the H.248 protocol.

8. A method comprising:
receiving, at a media gateway, i) an upper threshold for a predetermined resource and ii) a resource request for the predetermined resource;
performing, based on the reception of the resource request, a calculation of resource utilization with respect to the predetermined resource, yielding a first result; and
when the first result exceeds the upper threshold, notifying a media gateway controller, the notification occurring with at least one instance of the predetermined resource still being available for use by the media gateway controller.

9. The method of claim 8 wherein the upper threshold and the resource request are received from the media gateway controller.

10. The method of claim 8 wherein the predetermined resource is digital signal processing channels.

11. The method of claim 8 wherein the predetermined resource is UDP ports.

12. The method of claim 8 further comprising receiving a lower threshold for the predetermined resource, wherein the lower threshold is less than the upper threshold.

13. The method of claim 8 wherein the media gateway receives the resource request in accordance with the H.248 protocol.

14. A method comprising:
receiving, at a media gateway, i) an upper threshold for a predetermined resource, ii) a lower threshold for the predetermined resource, the lower threshold being less than the upper threshold, and iii) a resource request for the predetermined resource;
performing, based on the reception of the resource request, a calculation of resource utilization with respect to the predetermined resource, yielding a first result; and
when the first result either exceeds the upper threshold or falls below the lower threshold, notifying a media gateway controller.

15. The method of claim 14 wherein the notification occurs with at least one instance of the predetermined resource still being available for use by the media gateway controller.

16. The method of claim 14 wherein the upper threshold and the resource request are received from the media gateway controller.

17. The method of claim 14 wherein the predetermined resource is digital signal processing channels.

18. The method of claim 14 wherein the predetermined resource is UDP ports.

19. The method of claim 14 wherein the predetermined resource is TDM timeslots.

20. The method of claim 14 wherein the media gateway receives the resource request in accordance with the H.248 protocol.
